(19) United States
(12) Patent Application Publication
(10) Pub. No.: US 2018/0259171 A1
(43) Pub. Date: Sep. 13, 2018

(54) Light Ball Apparatus and Method

(71) Applicants: Clendon W. Pharr, Mobile, AL (US); Charles Parr, Eight Mile, AL (US); Michael Steven Spurlock, Chickasaw, AL (US)

(72) Inventors: Clendon W. Pharr, Mobile, AL (US); Charles Parr, Eight Mile, AL (US); Michael Steven Spurlock, Chickasaw, AL (US)

(21) Appl. No.: 15/760,279

(22) PCT Filed: Sep. 16, 2016
(86) PCT No.: PCT/US2016/052088

§ 371 Date: Mar. 15, 2018

Related U.S. Application Data
(60) Provisional application No. 62/219,155, filed on Sep. 16, 2015.

(51) Int. Cl. F21V 23/04; F21V 23/00; F21L 4/08; F21V 23/06; F21V 33/00; F21V 15/01; F21V 29/70; F21V 29/89; F21V 15/04

(52) U.S. Cl. CPC F21V 23/0435; F21V 23/005; F21V 23/0492; F21V 23/0471; F21L 4/08; F21V 23/06; F21Y 2107/50; F21V 23/0414; F21V 15/01; F21V 29/70; F21V 29/89; F21V 15/04; F21V 33/0056

(57) ABSTRACT

A light ball apparatus and method includes a remote controller device configured for transmitting and receiving data. A programmable ball is provided with an exterior shell with a top and a bottom and an interior. Two light sources are attached to a circuit board in the interior such that, when activated, light from one light source overlaps light from another light source. A power source is connected with the two light sources and circuit board combination and a transceiver is connected with the circuit board, the transceiver configured to transmit to, and receive data from, the remote controller.

### CROSS REFERENCE TO RELATED APPLICATIONS

This application claims the benefit of previously filed U.S. provisional patent application No. 62/219,155 filed Sep. 16, 2015 for a “Light Ball Apparatus and Method” and the PCT/US2016052088 application filed Sep. 16, 2016 for a “Light Ball Apparatus and Method”. The Applicants hereby claim the benefit of the provisional application and the PCT application under 35 U.S.C. § 119. The entire content of the provisional application and the PCT application is incorporated herein by this reference.

### FIELD OF THE INVENTION

This invention relates to an improved lighting device. In particular, in accordance with one embodiment, the invention relates to a light ball apparatus consisting of a remote controller device configured for transmitting and receiving data. A programmable ball is provided with an exterior shell with a top and a bottom and an interior. Two light sources are attached to a circuit board in the interior such that, when activated, light from one light source overlaps light from another light source. A power source is connected with the two light sources and circuit board combination and a transceiver is connected with the circuit board, the transceiver configured to transmit to, and receive data from, the remote controller.

### BACKGROUND OF THE INVENTION

A problem exists in situations that require lighting to be provided in locations where providing the lighting and placing the lighting where it is needed is dangerous. By way of example only and not by limitation, law enforcement officers and members of the military and first responders often have need of determining what obstacles, human or man made, they are facing Shining a light on the area is a risky behavior when involved in combat, for example only, since the light is easily traced back to its source. First responders may not be able to shine a light on areas they need illumination due to physical obstructions.

Further, conventional lighting sources create shadows and dark areas since the beam of light they produce is focused and presented in a single direction.

Still further, users often desire to obtain audio and visual input from the illuminated area but, again, are prevented by hostile humans or man made obstructions from obtaining audio and visual information from the desired location.

Thus, there is a need in the art for a lighting device that provides remote, multi-directional lighting, among other things, that does not place the user at risk.

It therefore is an object of this invention to provide a light ball apparatus and method that is deployable by a user to remote locations that does not place the user at risk, that provides improved multi-direction lighting that reduces shadows and dark spaces.

Further, inter alia, it is an object to provide a light ball that is remotely operable and that obtains audio and visual information from a remote location once deployed.

### SUMMARY OF THE INVENTION

Accordingly, the light ball apparatus and method of the present invention, according to one embodiment, includes a remote controller device configured for transmitting and receiving data. A programmable ball is provided with an exterior shell with a top and a bottom and an interior. Two light sources are attached to a circuit board in the interior such that, when activated, light from one light source overlaps light from another light source. A power source is connected with the two light sources and circuit board combination and a transceiver is connected with the circuit board, the transceiver configured to transmit to, and receive data from, the remote controller.

All terms used herein are given their common meaning so that “ball” identifies and describes a spherical shaped construct. Nonetheless, the present invention is not limited to a “sphere” shape and may in fact be in any useful shape, square, rectangle, triangle, or the like. “Programmable” describes a feature of the invention that includes software and hardware systems for manipulating the elements of the invention as described herein in any manner required by or deemed useful by the operator. “Light source” identifies a device that produces light such as Light Emitting Diodes (“LED”s) or incandescent bulbs or any light producing device now known or hereafter developed. The “remote controller” and the “transceiver” of the present invention are devices for transmitting and receiving signals from one to the other as are known in the art and not described more fully hereafter.

According to another aspect of the invention, the device further includes an accelerometer connected with the circuit board.

In another aspect, the two light sources are selected from a group consisting of: visible light and infrared light.

In one aspect, one light source is connected with one circuit board and another light source is connected with another circuit board and the circuit boards are connected at an angle to each other.

In a further aspect, the bottom of the programmable ball is weighted such that the light ball orients itself on a surface with the weighted bottom down in relation to the rest of the programmable ball.

In one aspect, a motion detector is connected with the circuit board.

In another aspect, the power source is a rechargeable battery and the light ball further includes a charging port in the exterior connected with the rechargeable battery.

In a further aspect, the exterior shell has a top and a bottom where the top is transparent and includes at least the two light sources connected with a circuit board and the bottom contains the power source.

In one aspect, the programmable ball further includes a camera and a microphone such that audio and visual images are captured and transmitted to the remote controller device.

According to another embodiment of the invention, the light ball apparatus includes a remote controller device configured for transmitting and receiving data. A programmable ball with an exterior shell with a top and a bottom and an interior is provided where the top is transparent and the bottom is weighted such that the programmable ball orients itself on a surface with the weighted bottom down in relation to the rest of the programmable ball. A first light source and a second light source are provided where the first light source is attached to a first circuit board in the interior and where the second light source is attached to a second circuit board in the interior such that, when activated, light from the first light source overlaps light from the second light source. A power source is connected with the first and second light sources and the circuit board combinations. And a transceiver is connected with the circuit boards, the transceiver configured to transmit to, and receive data from, the remote controller.

According to one aspect, the remote controller and the circuit boards are configured to operate the first and second light sources in accordance with options selected from a group consisting of: on and off, dim; flashing, and strobe.

In another aspect, the device further includes more than two light sources connected to circuit boards.

In a further aspect, the invention further includes an accelerometer connected with the circuit boards.

In one aspect, the two light sources are selected from a group consisting of: visible light and infrared light; and visible light or infrared light.

In another aspect, the device further includes a motion detector connected with the circuit boards.

In one aspect, the power source is a rechargeable battery and the programmable ball further includes a charging port in the exterior connected with the rechargeable battery.

In a further aspect, the programmable ball further includes a camera and a microphone such that audio and visual images are captured and transmitted to the remote controller device.

In another aspect, the invention further includes a temperature monitor connected with the light sources and a power source monitor connected with the power source such that the temperature of the light sources and the capacity of the power source is monitored.

According to another embodiment, a light ball method consists of:
a. providing a remote controller device configured for transmitting and receiving data; and a programmable ball with an exterior shell with a top and a bottom and an interior; with two light sources attached to a circuit board in the interior such that, when activated, light from one light source overlaps light from another light source; and a power source connected with the two light sources and circuit board combination; and a transceiver connected with the circuit board configured to transmit to, and receive data from, the remote controller;
b. deploying the programmable ball; and
c. activating the light sources.

In another aspect, the method further includes using the remote controller device to operate the programable ball to manipulate the light sources after deployment, the manipulation selected from a group consisting of: on and off, dim; flashing, and strobe.

### DESCRIPTION OF THE DRAWINGS

Other objects, features and advantages of the present invention will become more fully apparent from the following detailed description of the preferred embodiment, the appended claims and the accompanying drawings in which:

FIG. 1 is a perspective view of the light ball of the present invention;

FIG. 2 is another perspective view of the invention of FIG. 1 showing more of the bottom;

FIG. 3 is a side view of the invention of FIG. 1; and

FIG. 4 is a top view of the invention of FIG. 1.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

It should also be noted that a plurality of hardware and software devices, as well as a plurality of different structural components, may be utilized to implement the invention. Furthermore, and as described in subsequent paragraphs, the specific configurations illustrated in the drawings are intended to exemplify embodiments of the invention and that other alternative configurations are possible.

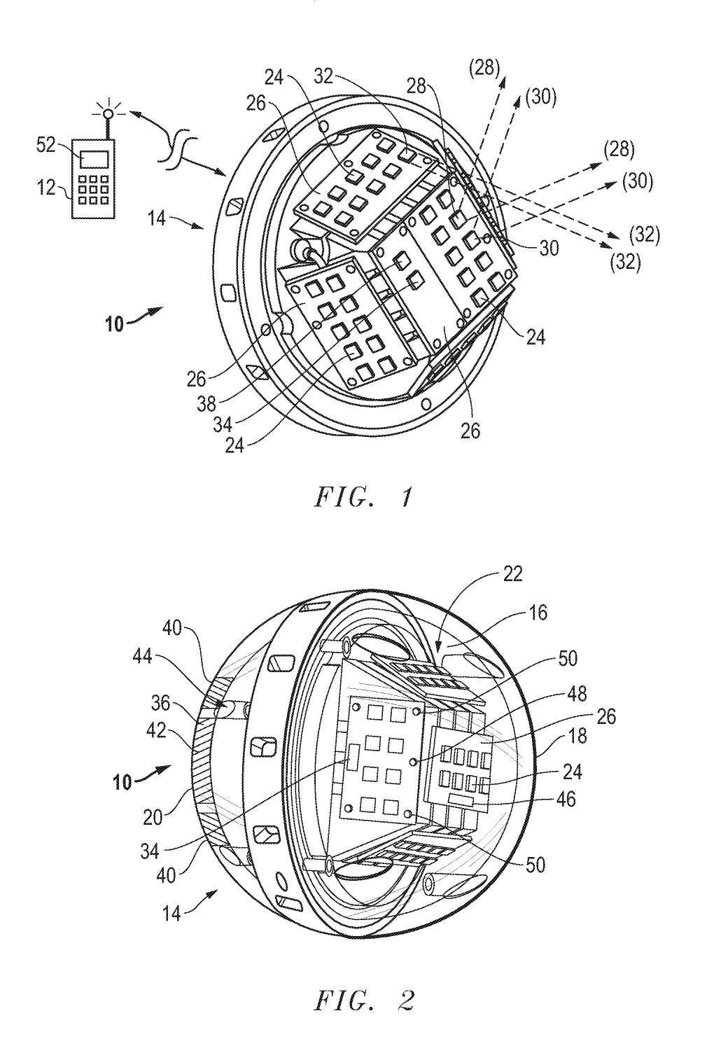

A preferred embodiment of the present invention is illustrated by way of example in FIGS. 1-4. With specific reference to FIGS. 1 and 2, light ball apparatus 10 according to a preferred embodiment includes a remote controller device 12 for transmitting and receiving data, signals. Again, remote controller device 12 may be any form of device now known or hereafter developed for accomplishing the purposes of the present invention including a smart phone with an app or any other communications device now known or hereafter developed. Remote controller 12 transmits and receives signals to and from programmable ball 14. Programmable ball 14 includes an exterior shell 16, top 18, and bottom 20. Exterior shell 16 creates an interior 22 (see e.g. FIGS. 2 and 3) within which operable elements of the invention are disposed as will be described more fully hereafter.

Two light sources 24 are attached to a circuit board 26 located in the interior 22 such that, when activated, light from one light source 24 overlaps light from another light source 24. Referring specifically to FIG. 1, for purposes of illustration, a first light source 28 is connected with circuit board 26 and another light source 30 is connected to circuit board 26. Light (shown as dashed lines) from light source 28 overlaps light (shown in dashed lines) from light source 30. This overlapping feature is an important and unique aspect of the present invention solving a long felt need in the art for reducing and/or eliminating shadows created by unidirectional single light devices.

FIG. 1 also shows a preferred embodiment of the invention in which multiple circuit boards 26 are provided with multiple light sources 24 connected with each circuit board 26. Importantly, a unique feature of the present invention is that when present each of the circuit boards 26 are secured within the interior 22 at an angle to each other. This is shown where light source 24, numbered as a third light source 32, is connected to a second circuit board 26 which is located at an angle with regard to the circuit board 26 containing light sources 28 and 30. As a result of this feature, light source 32 casts light that overlaps light from light sources 28 and 30.

FIG. 1 shows a transceiver 34 connected with circuit board(s) 26 and FIG. 2 shows power source 36 connected with the circuit boards 26 and light sources 24 and other elements of the invention requiring an independent power source. One such element is an accelerometer 38. Accelerometer 38, when present, functions as known and provides data relevant to speed, orientation and activity of light ball 10 as may be deemed useful to a user.

In one aspect, as shown in FIG. 2, light ball 10 includes a weight 40. Weight 40 is located at the bottom 20 of programmable ball 14. Weight 40 may be any type of weight and, for example only, weight 40 may be provided in the form of power source 36 in the form of a rechargeable battery 42 with a charging port 44 in the exterior shell 16.

Additionally, light ball apparatus 10, in one aspect, includes a motion detector device 46 that detects motion of objects close to light ball apparatus 10. Programmable ball 14 may include response programs that, for example only, upon detection of motion by motion detector 46, turns on light sources 24.

Still referring to FIGS. 1 and 2, programmable ball 14, in one aspect of the invention, further includes a camera 48 and a microphone(s) 50 such that audio and visual images are captured and transmitted to the remote controller device 12. In this case, remote controller device 12 includes a audio/visual display system 52 for viewing and listening to the audio and visual data obtained. This illustrates the flexibility of the present invention to accommodate different needs and changing circumstances.

In one aspect of the invention, a user can select operation of the light sources 24 from a list of options, for example only, of: on and off, dim, flashing, and strobe. Likewise, various combinations of different types of light, infra red or observable, for example only, may be selected as from a group consisting of: visible light and infrared light; and visible light or infrared light. Thus, one circuit board 26 may contain a variety of types of light producing light sources 24 or each circuit board 26 may contain only one type of light source, all as desired or deemed useful.

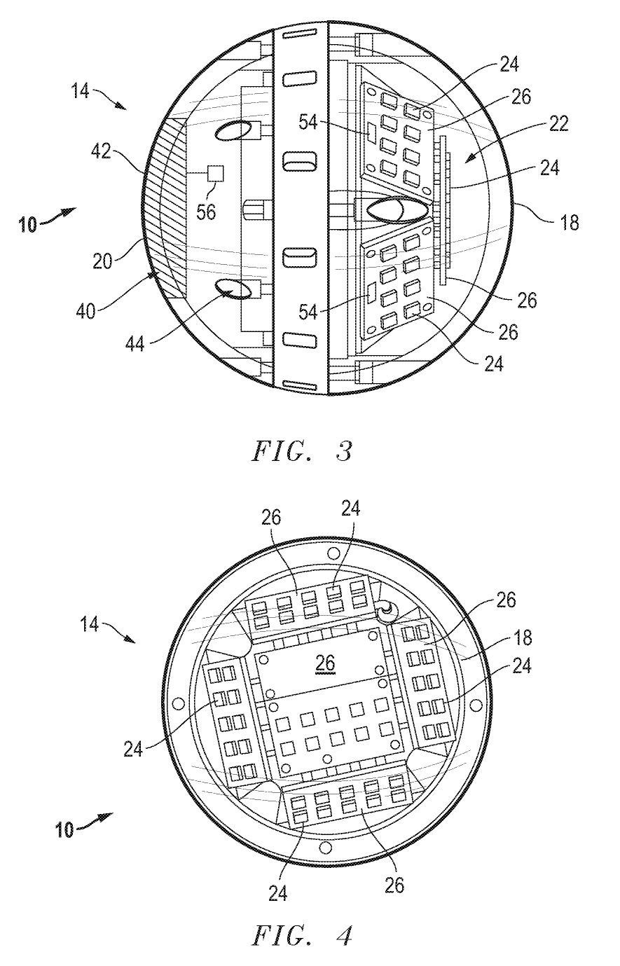

Referring to FIGS. 3 and 4, in one aspect, a temperature monitor 54 is connected with light sources 24 and a power source monitor 56 connected with the power source 36 such that the temperature of light sources 24 and the capacity of the power source 36 are monitored. A user can determine, for example only, how much time is left for powering the lights and whether the lights are reaching a critical temperature and need to be turned off.

By way of further explanation, the light ball apparatus 10 is comprised of two primary components: a small handheld HMI programming device or remote controller device 12 and one or more programmable ball devices 14. The handheld HMI 12 preferably takes the form-factor of a small, hand-held remote control and programming device 12 that communicates to each programmable ball 14 via a MAC/PHY unicast method via an embedded 900 MHz ISM radio system.

The handheld HMI 12 shall contain and potentially support the following peripheral devices:
Central control board with MCU, ISM Radio and adequate I/O to support agreed upon peripheral array
Minimum 16×2 LCD character display to provide human readable interactive content for the user (with optional backlight)
Minimum 4 button HMI interface (1-touch soft-key mode OR Up/Down/Enter/Back)
Potential 10-key keypad
Potential user assignable F-Keys for user programmable functions
Audible feedback for peripheral interaction and operational control cues
Targeted 9V battery operation (3.7V-10V capable)

The programmable ball device 14 shall, preferably, take the form-factor of a small ˜115 mm diameter ball 14 with a transparent upper hemisphere 18 for light emission and radio spectrum reception, along with a lower hard anodized aluminum hemisphere, bottom 20 providing a physical counterweight 40 and battery housing with access to a 5-pin balance charge connection 44 to recharge the internal LiPO battery pack 42. Active thermal monitoring 54 shall also be required to prevent thermal runaway of the LED's 24 in high-output conditions and ensure, by means of power monitor 56, adequate remaining voltage capacity for the controls.

At a minimum the programmable ball preferably is comprised of:
four individual “light panel” PCB's, printed circuit boards 26, each consisting of (4) OSRAM Duris LED (˜470 lumens each) and Linear Boost converters
one top mounted central control board 26 with MCU w/integral thermistor, 3-Axis accelerometer 38, ISM Radio and PWM dimming controls to each light panel
Minimum 4 S/3 C LiPO battery back 42

The light ball system 10 provides a simple, yet flexible and powerful programmable control scheme to address the type of tactical lighting operation deemed necessary by the end user. To provide this high-level of programmability and operation, a collection of programmable inputs, triggers, timers, and lighting modes are combinable to specify and create a unique lighting control “scenario”.

Programmable lighting modes at a minimum shall preferably include:
ON command
OFF command
DIM command (to preset dimming level)
STROBE command (at a preset 50% duty cycle rate)
   Trigger Events at a minimum shall include:
Remote RF signal from HMI
Static→Motion Inertial threshold trigger from accelerometer (via programmable thresholds)
Motion→Static Inertial threshold trigger from accelerometer (via programmable thresholds)
Potential orientation trigger from accelerometer
   “Scenario” definitions shall defined by a collection of “sequence steps” wherein each step is defined as follows:
Trigger Event
Timing Operation
Lighting Mode
   Additional programmable auxiliary functions shall include at a minimum:
Thermal threshold action
Low LiPO voltage action

By way of continued explanation, portable light ball apparatus and method 10 is designed, preferably, for use by police and military but can also be used as emergency lighting or for any other lighting application. Portable light ball 10 has an array of LED lights, for example only, mounted to several printed circuit boards. The circuit boards are mounted in the interior 22 of the programmable ball 14 at different angles in such a manner that light overlaps and eliminates shadows or dark areas within a given space in a room when the ball is illuminated. The ball 14 is equipped with an intelligent circuit and microprocessor and a transceiver which allows for long distance remote control of various functions such as on/off and brightening or dimming. Other functions of the remote control include selectable modes such as flashing the lights like a strobe.

The programmable ball 14 houses an array of very bright LEDs 24 for lighting a room or passageway for room clearing in tactical situations, for example only. Circuit boards 26 may have infra-red LED emitters for use with night vision systems such the invention can be used as a stealth marking system.

Each programmable ball 14 includes a simplified remote control device for on/off function and, in one aspect, a master remote controller 12 that includes an Oled audio visual display 52 with many programming options and easy user interface for multi-functioning programming.

The programmable ball 14 is preferably weighted heavier to the bottom 20 of the ball so that when launched or tossed it sits upright when it comes to rest. This ensures that the light panels disperse light to the walls and ceiling without shadow as long as the ball 14 is clear from obstruction.

Preferably the programable ball 14 is composed of an aluminum heat sink that the circuit boards 26 are mounted to and an upper and lower half sphere that attach to the heat sink. The upper and lower half preferably are made of high impact polycarbonate and the complete unit is designed to be robust and handle impacts without damaging the ball either inside or out or the elements located within.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. A light ball apparatus comprising:
a. a remote controller device configured for transmitting and receiving data;
b. a programmable ball with an exterior shell with a top and a bottom and an interior;
c. two light sources attached to a circuit board in said interior such that, when activated, light from one light source overlaps light from another light source;
d. a power source connected with said two light sources and circuit board combination; and
e. a transceiver connected with said circuit board configured to transmit to, and receive data from, said remote controller device.

2. The apparatus of claim 1 further including an accelerometer connected with said circuit board.

3. The apparatus of claim 1 wherein said two light sources are selected from a group consisting of:
visible light and infrared light.

4. The apparatus of claim 1 wherein one light source is connected with one circuit board and another light source is connected with another circuit board and wherein said circuit boards are connected at an angle to each other.

5. The apparatus of claim 1 wherein said bottom of said programmable ball is weighted such that said light ball orients itself on a surface with weighted bottom down in relation to the rest of the programmable ball.

6. The apparatus of claim 1 further including a motion detector connected with said circuit board.

7. The apparatus of claim 1 wherein said power source is a rechargeable battery and wherein said light ball further includes a charging port in said exterior connected with said rechargeable battery.

8. The apparatus of claim 1 wherein said top of said exterior shell is transparent and said two light sources connected with a circuit board are located in the interior and covered by said transparent top and wherein said bottom contains said power source.

9. The apparatus of claim 1 wherein said programmable ball further includes a camera and a microphone such that audio and visual images are captured and transmitted to said remote controller device.

10. A light ball apparatus comprising:
a. a remote controller device configured for transmitting and receiving data;
b. a programmable ball with an exterior shell with a top and a bottom and an interior wherein said top is transparent and said bottom is weighted such that said programmable ball orients itself on a surface with weighted bottom down in relation to the rest of the programmable ball;
c. a first light source and a second light source wherein said first light source is attached to a first circuit board in said interior and wherein said second light source is attached to a second circuit board in said interior such that, when activated, light from the first light source overlaps light from the second light source;
d. a power source connected with said first and second light sources and said circuit board combinations; and
e. a transceiver connected with said circuit boards configured to transmit to, and receive data from, said remote controller.

11. The apparatus of claim 10 wherein said remote controller and said circuit boards are configured to operate said first and second light sources in accordance with options selected from a group consisting of: on and off, dim, flashing, and strobe.

12. The apparatus of claim 10 further including more than two light sources connected to circuit boards.

13. The apparatus of claim 10 further including an accelerometer connected with said circuit boards.

14. The apparatus of claim 10 wherein said two light sources are selected from a group consisting of: visible light and infrared light; and visible light or infrared light.

15. The apparatus of claim 10 further including a motion detector connected with said circuit boards.

16. The apparatus of claim 10 wherein said power source is a rechargeable battery and wherein said programmable ball further includes a charging port in said exterior connected with said rechargeable battery.

17. The apparatus of claim 10 wherein said programmable ball further includes a camera and a microphone such that audio and visual images are captured and transmitted to said remote controller device.

18. The apparatus of claim 10 further including a temperature monitor connected with said light sources and a power source monitor connected with said power source such that the temperature of said light sources and the capacity of said power source is monitored.

19. A light ball method comprising:
a. providing a remote controller device configured for transmitting and receiving data; a programmable ball with an exterior shell with a top and a bottom and an interior; with two light sources attached to a circuit board in said interior such that, when activated, light from one light source overlaps light from another light source; and a power source connected with said two light sources and circuit board combination; and a transceiver connected with said circuit board configured to transmit to, and receive data from, said remote controller;
b. deploying said programmable ball; and
c. activating said light sources.

20. The method of claim 19 further including using said remote controller device to operate said programable ball to manipulate said light sources after deployment said manipulation selected from a group consisting of: on and off, dim, flashing, and strobe.
